(19) United States
(12) Patent Application Publication
(10) Pub. No.: US 2009/0014478 A1
(43) Pub. Date: Jan. 15, 2009

(54) Tube/Straw Holder for Containers

(76) Inventor: Pitts Northrope Bellinger, JR., Goose Creek, SC (US)

Correspondence Address: PITTS NORTHROPE BELLINGER, JR., 105 RETRIEVER LANE, GOOSE CREEK, SC, 29445, US

(21) Appl. No.: 11/775,200

(22) Filed: Jul. 9, 2007

(51) Int. Cl. B67D 5/06

(52) U.S. Cl. 222/538

(57) ABSTRACT

A tube/straw holder/storage apparatus to be used with pressurized aerosol cans or other containers using straws or tubes. The tube/straw holder/storage apparatus consists of a hollow elongated compartment closed on one end and open on the other, with the open end having friction tabs formed so that the open end of elongated compartment is substantially closed off by the friction tabs. The purpose of these friction tabs being to snuggly hold in place tubes/straws when inserted into the elongated compartment for storage, after use. The tube/straw holder/storage apparatus attaches to cans or containers using two methods. First, an integral “C”-shaped pressure/friction clamp formed approximately perpendicular to the elongated cross section of the elongated storage compartment is used to fit around the sidewall of the cans/containers. Second, tabs formed integrally onto the sidewall of the elongated compartment will allow for elastic bands to be attached to the elongated compartment and stretch around cans or containers for added security. In an alternate embodiment, the tube/straw holder/storage apparatus will not have the “C”-shaped pressure/friction clamp and attaches to cans or containers using only the elastic bands attached to the elongated compartment's integral tabs and stretching around cans or containers. In all embodiments, the elongated compartment is attached to cans/containers in a manner making the elongated compartment substantially adjacent and parallel to cans/containers with the closed end positioned towards the bottom of cans/containers.

### RELATED PATENTS

None

### BACKGROUND OF THE INVENTION

The present invention primarily pertains to aerosol cans/containers having a push-button spray valve and having a dispensing tube/straw supplied which is inserted into the orifice of the spray valve for more precise dispensing of the fluid contained in the can/container. This dispensing tube/straw is usually taped to the side of the can/container when packaged for shipment or sale. When the tube/straw is initially used, it must be removed from the taped area of the can/container. Once used, re-attaching the tube/straw can be cumbersome or difficult, especially when the tape loses its adhesive properties. This often results in loss or misplacement of the dispensing tube/straw. The present invention is an apparatus that allows for easy storage and re-use of the tube/straw and secures the tube/straw to the can/container when not in use, thereby minimizing loss or misplacement of the dispensing tube/straw.

### DISCUSSION OF PRIOR ART

There are several patented devices that attempt to address at least the problem of losing or misplacing the tube/straw, some of which are:

U.S. Pat. No. 4,819,838—Hart, Jr. describes a device having a ring that is secured to the can or a cap for the can. A tab or arm is attached to the ring and has an aperture through which the tube is inserted.

U.S. Pat. No. 5,058,783 describes a device with a construction that includes a support body and a holding element for holding a spray tube. A securing element attaches the support body to the spray container and a connected element attaches the holding element and the spray tube to the support body.

U.S. Pat. No. 4,823,445 describes a clip for holding a spray tube on a spray can and having a mounting strap that retains the clip to the side wall of the can.

U.S. Pat. No. 5,544,783 discloses a C-shaped clip-on device for holding a tube on an aerosol container, the device having a friction fit and elastic to be at ached to the side wall of an aerosol container and having two integral smaller c-shaped brackets, formed so that they may receive by friction fit a tube or straw.

U.S. Pat. No. 5,178,354 describes a device which attaches to the side of a can and having two resilient tabs between which a dispensing tube is meant to be secured.

U.S. Pat. No. 5,544,783 describes a device consisting of a ring fitting around a can and having one or more small integrated c-shaped clips for attaching dispensing tubes.

U.S. Pat. No. 5,788,129 describes a device consisting of a tab-strap attaching to the side of a can, with the dispensing tube attaching to the end of the tab-strap and which the tab-strap swings upward to allow the attached tube to be inserted into the spray valve orifice.

U.S. Pat. No. 5,988,575 describes a device that is comprised of a clip fitting around a can with multiple integrated attachments including at least one used to secure a dispensing tube.

U.S. Pat. No. 6,269,985 describes a device comprising an apertured retention tab that is mountable to the side of the can which is flexible between two positions and that seems to pinch the dispensing tube to the side of the can thereby securing the tube to the can when not in use.

U.S. Pat. No. 6,412,671 describes a device that uses a flexible material making up a flexible ring to fit around the can and an attached tether line with the tube being attached to the end of said tether line.

There have been many attempts to design a device for securing a dispensing tube/straw to a can/container, which is easy to use and economical to manufacture. The present invention addresses these aspects and has both a unique method of storing the tube/straw and also has the unique function of containing any residual fluids that may drain from the tube/straw while stored and secured to the can/container.

### SUMMARY OF THE PRESENT INVENTION

The present invention is a tube/straw holder/storage apparatus to be used with pressurized aerosol cans or other containers using straws or tubes. Many pressurized cans or containers have small dispensing tubes or straws supplied with them. These tubes or straws are meant to be inserted into the exit orifice of the can/container's spray valve to allow for more precise dispensing of the fluid contained in the can or container. The present invention's purpose being to help prevent loss or misplacement of tubes or straws that have an associated use with the can or container with which they were supplied. The tube/straw holder/storage apparatus consists of an elongated compartment closed on one end and open on the other, with the open end having friction tabs formed so that the open end of elongated compartment is substantially closed off by the friction tabs. The elongated compartment will serve to store the dispensing tube/straw and will also contain any residual fluids that may drain from the tube/straw while not in use. The purpose of the friction tabs being to snuggly hold tubes/straws in place while stored in the elongated compartment when tubes/straws are not in use. The elongated compartment is hollow to allow for insertion and storage of tubes or straws, and may have a crescent shaped cross section as depicted in the illustrations or may have a circular cross section, but is not meant to be limited to these shaped cross sections. The tube/straw holder/storage apparatus attaches to cans or containers using two methods. First, an integral “C”-shaped pressure/friction clamp formed approximately perpendicular to the elongated cross section of the elongated storage compartment is used to fit around the sidewall of the cans/containers. Second, tabs formed integrally onto the sidewall of the elongated compartment will allow for bands or straps to be attached to the elongated compartment and stretch around cans or containers for added security. In an alternate embodiment, the tube/straw holder/storage apparatus will not have the “C”-shaped pressure/friction clamp and attaches to cans or containers using only the elastic bands attached to the elongated compartment's integral tabs and stretching around cans or containers. In all embodiments, the elongated compartment is attached to cans/containers in a manner making the elongated compartment substantially adjacent and parallel to cans/containers with the closed end positioned towards the bottom of cans/containers. The present invention may be used with aerosol cans with dispensing tubes/straws or any container using tubes or straws of various sizes.

### OPERATION

The tube/straw holder/storage apparatus is meant to attach to a can or container first. This may be accomplished in multiple ways. First, one may simply fit the “C”-shaped friction clamp around the sidewall of the can or container, as shown in FIGS. 5 and 6. This should be sufficient for household or light use cans or containers. Cans or containers in heavy use, such as in automotive service shops or manufacturing operations, may require an even more secure attachment. This can be accomplished by additionally using elastic bands attached to tabs formed integrally onto the sidewall of the elongated compartment, and stretching the elastic bands around the sidewall of the can or container. FIGS. 1, 2, and 8 demonstrate how elastic bands will attach to the tube/straw holder/storage apparatus via the integral tabs. FIGS. 11 and 12 demonstrate how elastic bands will attach to the tube/straw holder/storage apparatus, and stretch around cans for securing. When elastic bands are used, the operation of attachment is identical for both embodiments described in this patent. The alternate embodiments (FIGS. 8 through 12) will allow for attachment to cans/containers using only the elastic bond method. Once attached to its host container, the tube/straw holder/storage apparatus will serve to store and help prevent loss of the tube or straw associated with the host container. When the tube or straw is needed for use, the user simply grasps the portion of the tube or straw that protrudes from the open end of the elongated compartment, and withdraws it for its intended use. After use, the tube or straw is inserted back into elongated compartment; the tube or straw passing through the friction tabs; and remains stored in the elongated compartment until its next use. The tube or straw will remain securely stored in the elongated compartment, as it is held in place by the friction grip of the friction tabs. FIG. 2 shows how a tube or straw will be positioned in the straw/tube holder/storage apparatus while not in use.

If the can or container is expendable, such as an aerosol can, the tube/straw holder/storage apparatus may be detached from the expended can or container and re-attached to another can or container for reuse.

### CONCLUSIONS, RAMIFICATIONS AND SCOPE

The reader will see that that the tube/straw holder/storage apparatus will serve to help prevent the long-standing problem of loss of precision application tubes/straws that may be supplied with aerosol cans. It may also be concluded that the said problem is accomplished in a unique and practical way. The method of storing and securing the tubes or straws allows for easy access to and manipulation of the tubes or straws. Additional advantages over other devices are the tube/straw holder/storage apparatus' simplicity and the added function of containing any residual fluids that may drain from stored tubes or straws after they have been used. It should also be concluded that the tube/straw holder/storage apparatus is not limited to use with pressurized or aerosol cans and may be used with any container that may use or need a straw or tube.

### EXPLANATION OF DRAWINGS—FIGURES

Broken lines in drawings represent the approximate inside walls of the hollow portion of the elongated compartment. In FIG. 2, there are also broken lines representing the portion of a tube/straw that will be inside the elongated compartment; indicated by reference numeral 20.

FIG. 1 shows a visually angled view of the straw/tube holder/storage apparatus.

FIG. 2 shows a visually angled view of the straw/tube holder/storage apparatus demonstrating how a tube/straw will be stored in the elongated compartment.

FIG. 3 shows a side view of the straw/tube holder/storage apparatus.

FIG. 4 shows an overhead view of the straw/tube holder/storage apparatus showing the “C”-shaped clamp and the arrangement/design of the friction tabs.

FIGS. 5 and 6 show the side view and overhead view, of the straw/tube holder/storage apparatus, respectfully as it would attach to cans/containers.

FIG. 7 is an enlarged overhead image of the elongated storage compartment showing the arrangement of the friction tabs. The number of friction tabs will be a sufficient number to securely hold in place an inserted tube or straw.

FIG. 8 shows a visually angled view of an alternate embodiment of the straw/tube holder without the “C”-shaped pressure/friction clamp. This illustration gives a view of this design, which allows for elastic bands to attach to the straw/tube holder and stretch around cans/containers.

FIG. 9 shows a side view of this embodiment. It shows the integral tubs on the elongated compartment, which allow for attachment of elastic bands.

FIG. 10 shows an overhead view of this embodiment showing the arrangement/design of the friction tabs.

FIGS. 11 and 12 show the side view and overhead view of the embodiment described in FIG. 8, respectfully as it would attach to cans/containers.

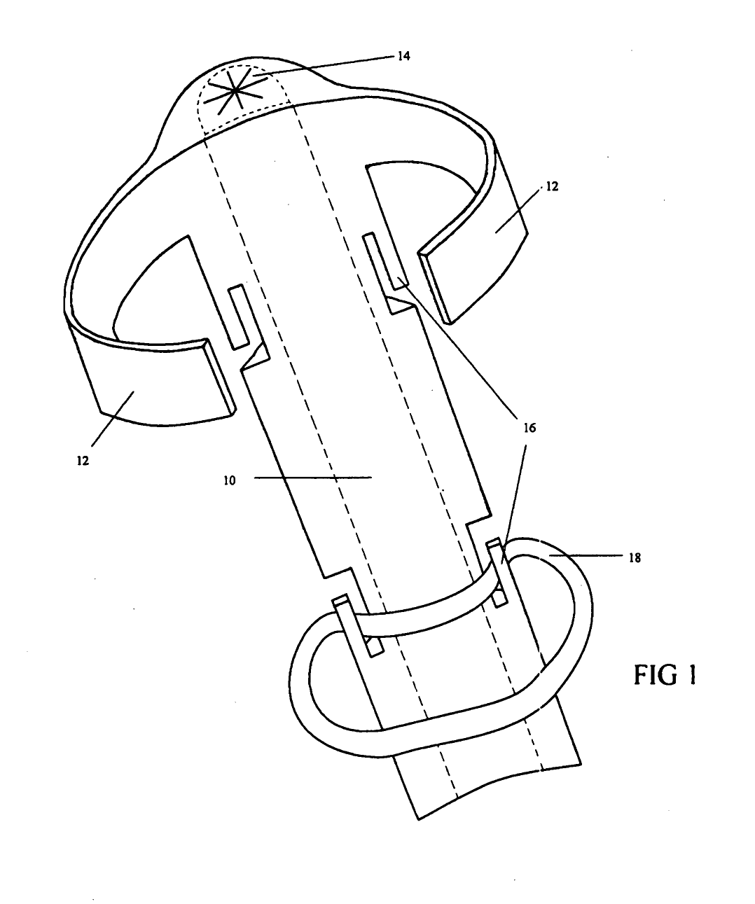

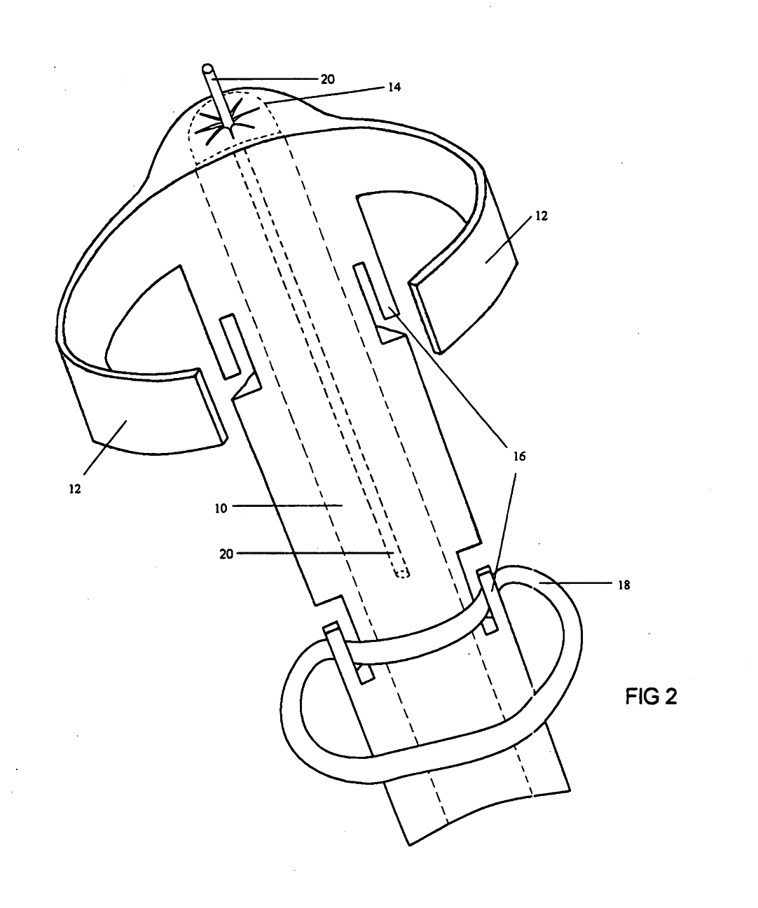

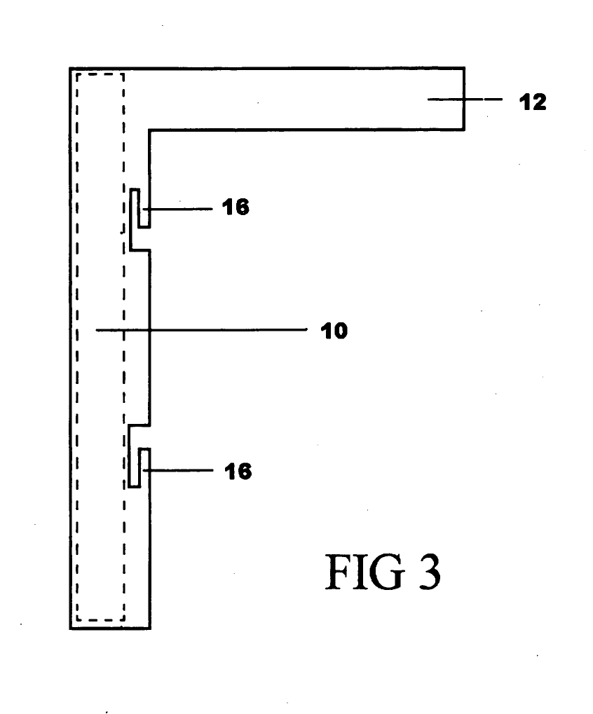

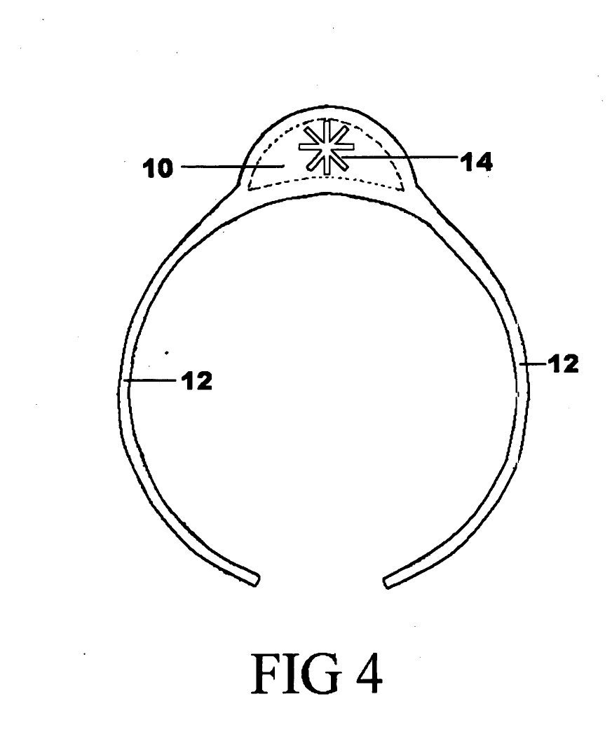

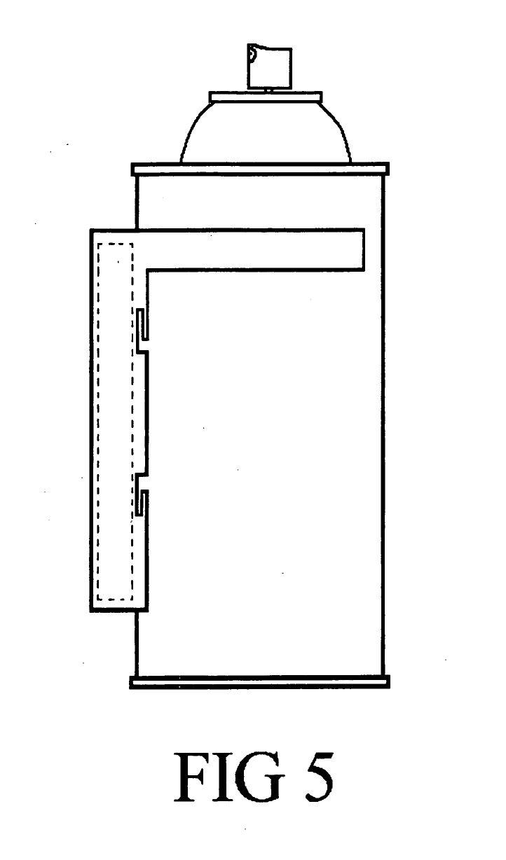

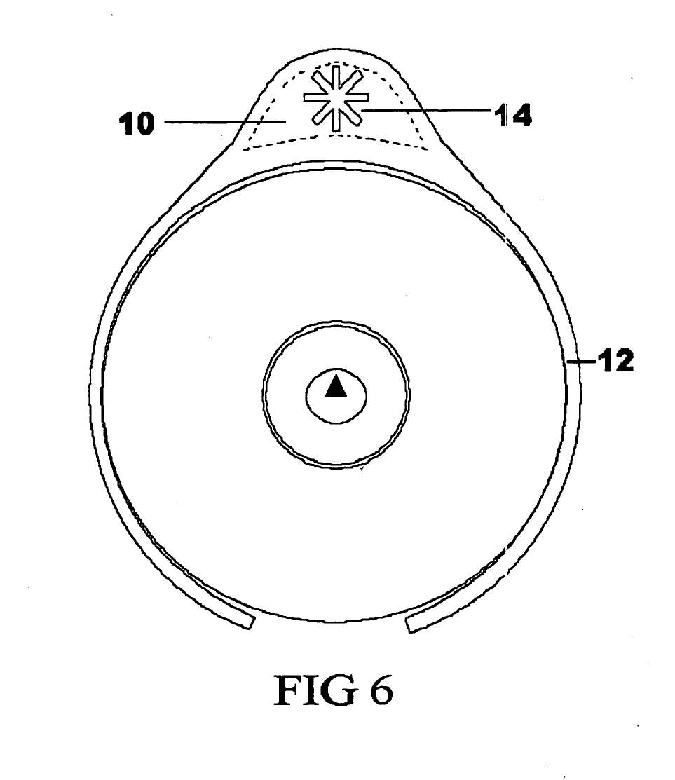

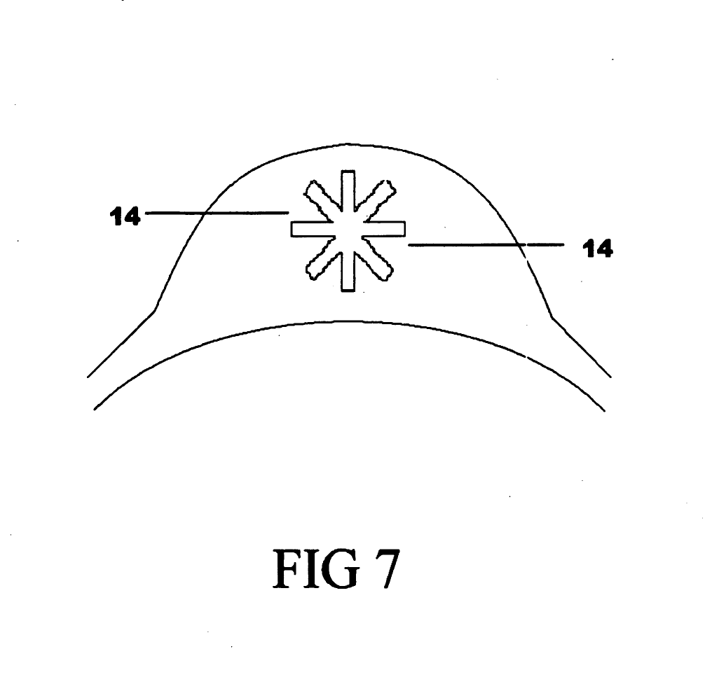

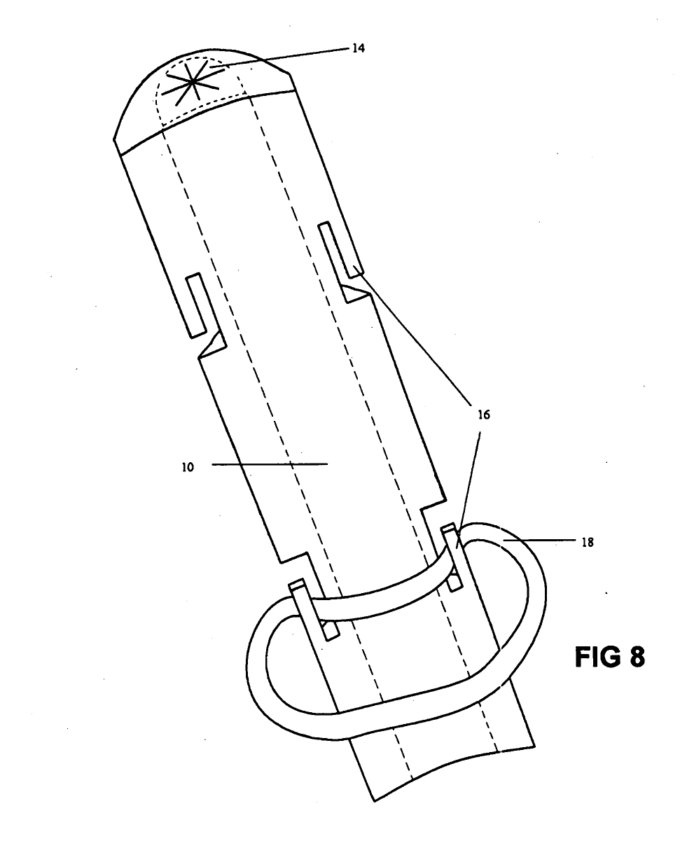

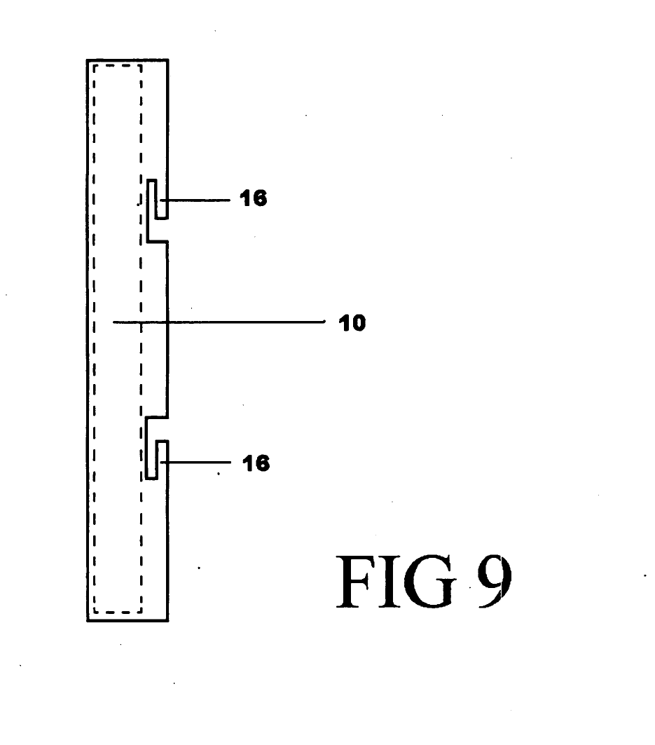

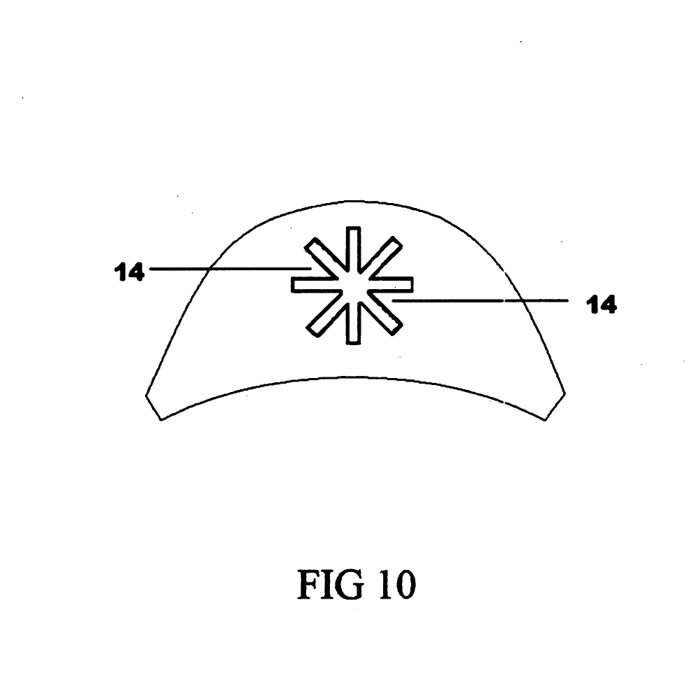

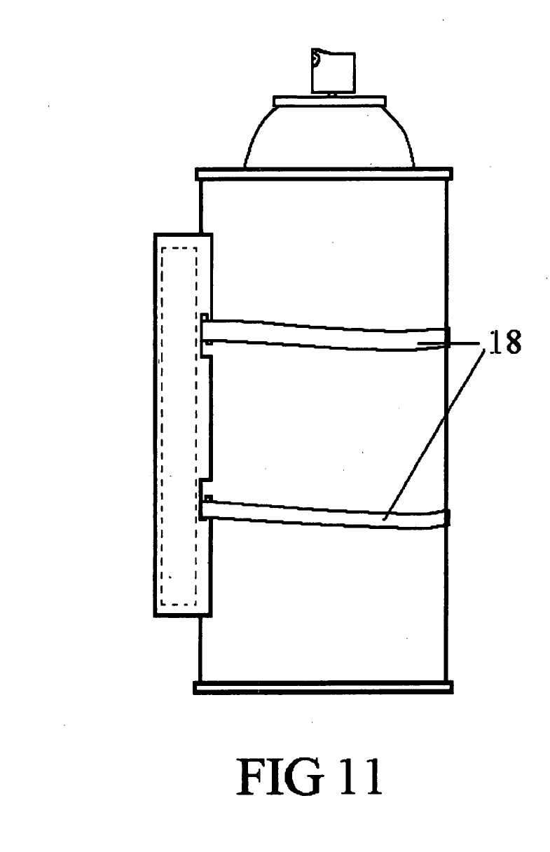

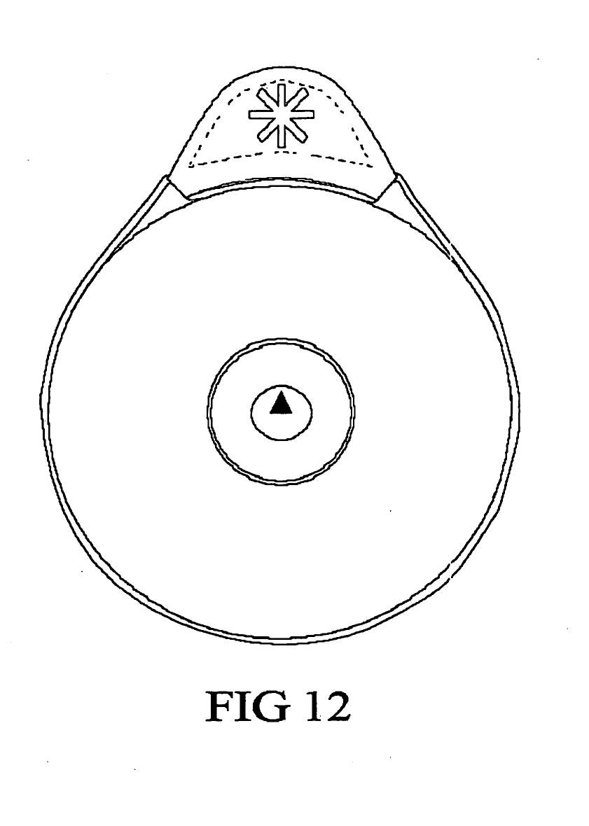

### EXPLANATION OF DRAWINGS—REFERENCE NUMERALS

10—Elongated compartment
12—C-shaped friction clamp
14—Friction tabs
16—Integral tabs for elastic band attachment
18—Elastic bands
20—Example of a tube or straw

Reference numeral 10 represents the elongated compartment used to store the tubes or straws. It is hollow with the bottom end being closed off in order to securely store the tube or straw and to contain any residual fluids that may drain from tubes or straws while they are stored.

Reference numeral 12 represents the “C”-shaped friction clamp, which is an integrated part of the elongated compartment. Its purpose is to snuggly fit around the sidewall of cans or containers thereby serving to hold the integrated elongated compartment immediately adjacent to the sidewall of cans or containers.

Reference numeral 14 represents the friction tabs that are positioned at the top end of the elongated compartment, opposite the closed end of the elongated compartment. The planar cross section of these tabs should be thin enough to be flexible but remain durable. The tabs may be an integrated part of the elongated compartment or may be part of a cap that may be threaded or otherwise attached onto the open end of the elongated compartment. The purpose of the tabs is to snuggly hold tubes or straws in position while stored in the elongated compartment. The number of tabs will be as few or as many as are required to accomplish snuggly holding the tubes or straws. Tubes or straws will protrude partially beyond the tabs outside the elongated compartment allowing for gripping and removal of tubes or straws when used. After a tube or straw is used, and is ready to be stored, the tube or straw will be inserted into the elongated compartment, passing through the friction tab area. As the tube or straw moves past the friction tabs, they will flex enough to allow the tube or straw to pass, but will remain in contact with the tube or straw to snuggly hold it in place.

Reference numeral 16 represents integral tabs on the elongated compartment which will allow attachment of elastic bands which will fit around cans or containers in order to hold the elongated compartment securely against the sidewall of cans or containers. The bands may be any type or made of any material that will accomplish the purpose said above and are not to be considered a unique item protected under this patent.

Reference numeral 18 represents elastic bands that may be used to attach the apparatus to cans/containers as described in the paragraph discussing reference numeral 16. The bands may be any type or made of any material that will accomplish the purpose of holding the elongated compartment securely against the sidewall of cans or containers and are not to be considered a unique item protected under this patent.

Reference numeral 20 represents a possible example of a tube or straw and is not to be considered a unique item protected under this patent.

What is claimed:

1. A tube/straw holder/storage apparatus comprising:
An elongated compartment closed on one end and open on the other, with the open end having friction tabs formed so that the open end of elongated compartment is substantially closed off by said friction tabs.

2. The elongated compartment in claim 1 having an integral “C”-shaped pressure/friction clamp formed approximately perpendicular to the elongated cross section of said elongated storage compartment.

3. The elongated compartment in claim 1 having tabs formed integrally onto the sidewall of said elongated compartment.

4. The elongated compartment in claim 1 having the primary function of acting as the storage receptacle for tubes and/or straws that have an associated use with cans/containers, thereby possibly preventing loss or misplacement of tubes and/or straws that have an associated use with cans/containers.

5. The elongated compartment in claim 1 having a secondary function of containing any residual fluids that may escape stored tubes and/or straws after use, thereby minimizing possible fluid contamination in storage areas where cans/containers are stored.

6. The friction tabs in claim 1 having the primary function of holding tubes/straws in place when tubes/straws are inserted into elongated compartment for storage.

7. The integral “C”-shaped friction clamp in claim 2 having the primary function of facilitating attachment of the elongated compartment in claim 1 to the sidewall of a host can/container.

8. The integral tabs in claim 3 having the primary function of allowing for elastic bands to be attached to the elongated compartment in claim 1 and stretch around cans/containers thereby facilitating additional security of said elongated compartment to the host cans/containers.

9. In an alternative embodiment, the elongated compartment in claim 1 will not have the integral “C”-shaped pressure/friction clamp in claim 2 and will attach to host cans/containers using the method described in claim 8 using the integral tabs in claim 3.
